(19) United States
(12) Patent Application Publication
(10) Pub. No.: US 2013/0046216 A1
(43) Pub. Date: Feb. 21, 2013

(54) SYSTEM FOR DEEP VEIN THROMBOSIS THERAPY INTEGRAL TO A PERSON SUPPORT APPARATUS

(71) Applicants: Christopher R. O'Keefe, Batesville, IN (US); David Ribble, Indianapolis, IN (US); Rachel Williamson, Batesville, IN (US); Timothy J. Receveur, Guilford, IN (US); Jason Amrhein, Batesville, IN (US); Jason Penninger, Indianapolis, IN (US)

(72) Inventors: Christopher R. O'Keefe, Batesville, IN (US); David Ribble, Indianapolis, IN (US); Rachel Williamson, Batesville, IN (US); Timothy J. Receveur, Guilford, IN (US); Jason Amrhein, Batesville, IN (US); Jason Penninger, Indianapolis, IN (US)

(21) Appl. No.: 13/213,592

(22) Filed: Aug. 19, 2011

(51) Int. Cl. A61H 7/00

(52) U.S. Cl. 601/149; 601/150

(57) ABSTRACT

The disclosure provides a system for DVT prevention and therapy coupled to a person support surface of a person-support apparatus. In one embodiment the system can include at least one bladder, a controller, a fluid supply unit and a valve assembly in one embodiment. The at least one bladder can be configured to provide percussion therapy or sequential compression to the lower limbs of the person supported on the person-support apparatus. The fluid supply unit can be configured to supply fluid to the at least one bladder via the valve assembly. The controller can control the opening and closing of the valve assembly depending on the pressure inside the at least one bladder. In another embodiment, the system for DVT prevention and therapy uses mechanical actuation devices to provide a mechanical stimulus to the patient's limb.

### BACKGROUND OF THE DISCLOSURE

This disclosure generally relates to a person-support structure for Deep Vein Thrombosis (DVT) therapy integrated therein.

In prevention or treatment of various ailments such as Deep Vein Thrombosis (DVT), patients require specialized therapy such as impulse therapy or sequential compression therapy. Sequential compression devices generally include a compression sleeve generally configured to wrap around a portion of the patient's extremity and comprising multiple fluid compartments. The compartments are intermittently pressurized to supply compressive pressure to areas where clotting may occur. Sequential compression therapy devices that are available in the market come in various forms such as boots, sleeves, hoses etc. and focus mainly on pressure controlling aspects while enveloping a patient extremity. While various devices targeted to DVT therapy have been developed, there is still room for improvement. Thus a need exists for further contributions in this area.

### SUMMARY OF THE DISCLOSURE

The present disclosure includes one or more of the features recited in the appended claims and/or the following features which, alone or in any combination, may comprise patentable subject matter.

One illustrative embodiment of the present disclosure includes a person-support apparatus comprising a system for Deep Vein Thrombosis (DVT) prevention or treatment. The system comprises at least one bladder, a controller and a fluid supply unit configured to supply fluid to the at least one bladder via a valve assembly. The at least one bladder can be removably coupled on at least one of a ticking unit and a person support surface, configured to provide percussion and vibration or sequential compression therapy. The controller can be configured to control the operation of the valve assembly connected to the at least one bladder. The system for DVT prevention and therapy may further include an alarming unit, activity log, integration with a hospital network and communication with electronic medical records to recommend therapeutic regimes.

Another illustrative embodiment of the present disclosure includes a person-support apparatus comprising a system for DVT prevention or treatment. The system for DVT prevention and therapy comprises at least one bladder, a controller and a fluid supply unit configured to supply fluid to the at least one bladder via a valve assembly. The at least one bladder can be integral to a ticking unit mounted on at least a part of a person support surface, configured to provide impulse therapy or sequential compression therapy. The controller can be configured to control the operation of the valve assembly connected to the at least one bladder. The system for DVT prevention or treatment may further include an alarming unit, activity log, integration with a hospital network and communication with electronic medical records to recommend therapeutic regimes.

Another illustrative embodiment of the present disclosure includes a person-support apparatus comprising a system for DVT prevention or treatment. The system for DVT prevention or treatment comprises at least one mechanical actuation device, integral, mounted on top of or below a ticking unit which in turn is mounted on at least a part of a person support surface, configured to provide impulse therapy or sequential compression therapy. A controller can be configured to control the operation of the at least one mechanical actuation device. The system for DVT prevention or treatment may further include an alarming unit, activity log, integration with a hospital network and communication with electronic medical records to recommend therapeutic regimes.

Additional features alone or in combination with any other feature(s), including those listed above and those listed in the claims and those described in detail below, can comprise patentable subject matter. Others will become apparent to those skilled in the art upon consideration of the following detailed description of illustrative embodiments exemplifying the best mode of carrying out the invention as presently perceived.

### BRIEF DESCRIPTION OF THE DRAWINGS

Referring now to the illustrative examples in the drawings, wherein like numerals represent the same or similar elements throughout.

FIG. 1 is a perspective side view of a person-support apparatus along with at least one bladder according to an embodiment of the disclosure;

FIG. 2 is a perspective side view of the person-support apparatus along with at least one bladder according to another embodiment of the disclosure;

FIG. 3 is a block diagram of a system for DVT prevention or treatment according to one embodiment of the disclosure;

FIG. 4 is a perspective view of the person support surface with a system for DVT prevention or treatment according to one embodiment of the disclosure;

FIG. 5 is a perspective view of the person support surface with a system for DVT prevention or treatment according to another embodiment of the disclosure;

FIG. 6A is a representation of a system for DVT prevention wherein the at least one bladder is integral to the ticking unit; and

FIG. 6B is a representation of a system for DVT prevention or treatment wherein the at least one bladder is mounted on top of the ticking unit.

FIG. 7 is a representation of a system for DVT prevention or treatment wherein the at least one mechanical actuation device provides mechanical simulation to the patient's limb.

### DETAILED DESCRIPTION OF THE DRAWINGS

While the present disclosure can take many different forms, for the purpose of promoting an understanding of the principles of the disclosure, reference will now be made to the embodiments illustrated in the drawings, and specific language will be used to describe the same. No limitation of the scope of the disclosure is thereby intended. Various alterations, further modifications of the described embodiments, and any further applications of the principles of the disclosure, as described herein, are contemplated.

One illustrative embodiment of the present disclosure includes a person-support apparatus comprising a system for DVT prevention or treatment. The system comprises at least one bladder, a controller and a fluid supply unit configured to supply fluid to at least one bladder via a valve assembly. At least one bladder can be removably coupled on a person support surface, the bladder configured to provide one of impulse therapy or compression therapy in one embodiment. The controller can be configured to control the operation of the valve assembly connected to at least one bladder depending on the pressure within the bladders.

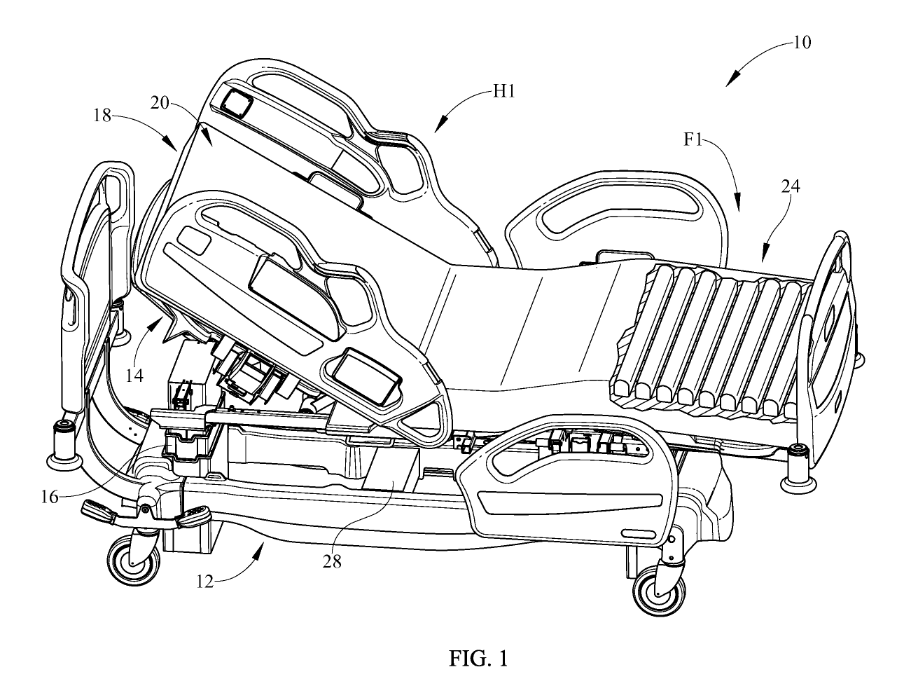

A person-support apparatus 10 according to one illustrative embodiment of the current disclosure is shown in FIG. 1. The person-support apparatus 10 includes a head section H1, where the head of a person is positioned, and a foot section F1, where the feet of a person can be positioned. In some contemplated embodiments the person-support apparatus 10 can also be a hospital stretcher, an operating table or any other person-support structure. The person-support apparatus 10 includes a lower frame 12, an upper frame 14 and a plurality of supports 16 supporting the upper frame 14 on the lower frame 12. In some contemplated embodiments, the supports 16 may be lift mechanisms configured to move the upper frame 14 with respect to the lower frame 12.

The person-support apparatus further includes a person-support surface 18 or a mattress 18 supported on the upper frame 14. The person-support surface 18 can be configured to support a person in multiple articulated positions. The person support apparatus 10 can further include a ticking unit 20 removably present over the person-support surface 18. In one embodiment the ticking unit 20 may be integral to the person-support surface 18.

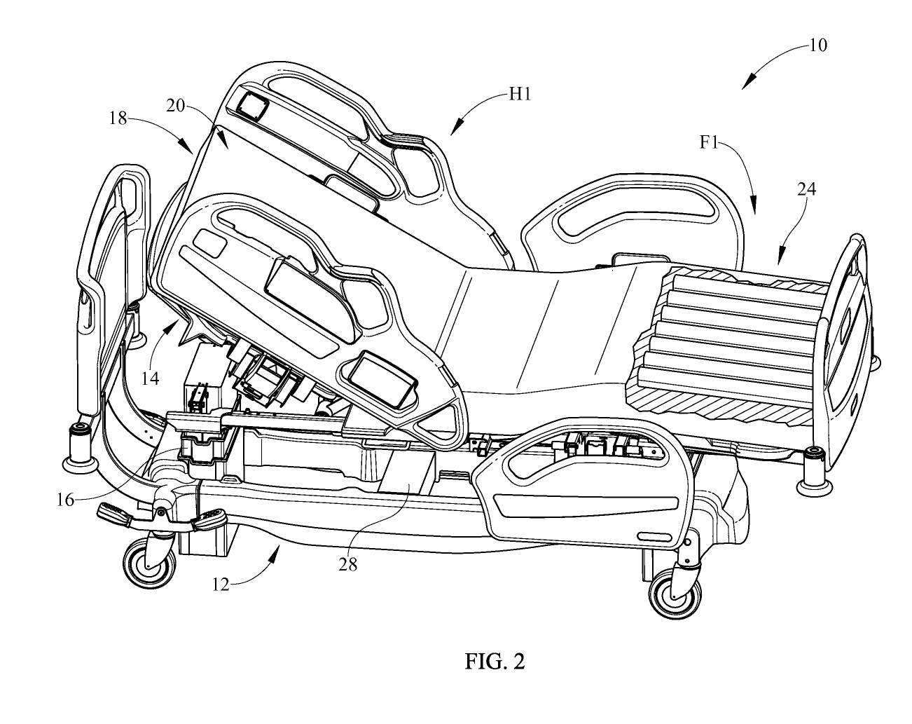

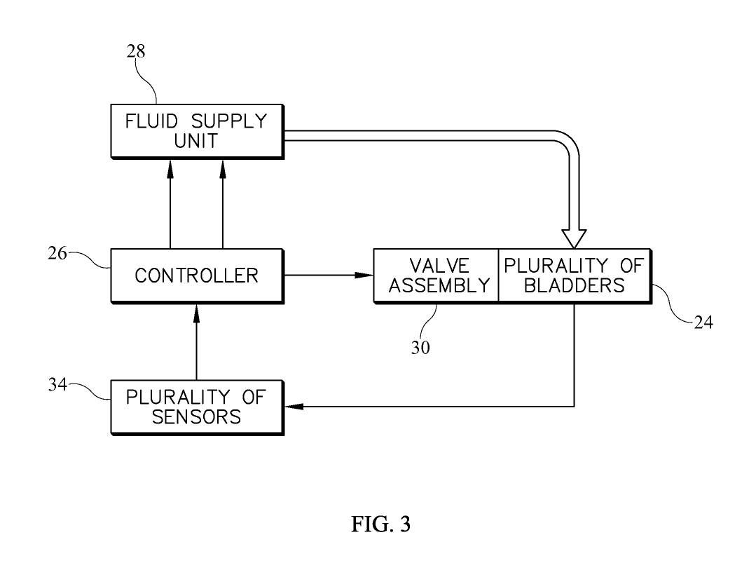

The person-support apparatus 10 includes a DVT therapy system 22 configured to provide one of impulse therapy or sequential compression therapy to a person supported on the person-support apparatus 10 according to an illustrative embodiment of the disclosure as shown in FIG. 1 and FIG. 2. The DVT therapy system 22 is positioned in the lower leg or calf section of the person-support apparatus 10. In other contemplated embodiments, the DVT therapy system 22 may be positioned in the upper body or thigh sections of the person-support apparatus 10. It should be appreciated that the DVT therapy system 22 can be removably attached to the person-support surface 18 of the person-support apparatus 10 in one embodiment. It should also be appreciated that the DVT therapy system 22 can be removed from the person-support surface 18 and stored at a separate location when the device is not in use. In one embodiment as shown in FIG. 1 to FIG. 7, the DVT therapy system 22 includes at least one bladder 24, a controller 26, a fluid supply unit 28, and a valve assembly 30. In one embodiment of the DVT therapy system 22, at least one bladder 24 can be configured to provide sequential compression or an impulse or percussion therapy to the lower limbs of the person supported on the person-support apparatus 10. In one embodiment of the DVT therapy system 22, at least one bladder 24 is coupled to the fluid supply unit 28. The fluid supply unit 28 can be configured to supply fluid to the at least one bladder 24 via a valve assembly 30. The controller 26 can be electrically coupled to the valve assembly 30 and connected to the at least one bladder 24. The controller 26 can control the opening and closing of the valve assembly 30 depending on the pressure inside the at least one bladder 24 and choice of the caregiver. It should be appreciated that the valve assembly 30 may also be configured to vary the rate at which fluid is supplied to at least one bladder 24. In one contemplated embodiment, the DVT therapy system 22 provides mechanical impulses with a frequency range of 30-45 impulses per minute for each of the patient's leg.

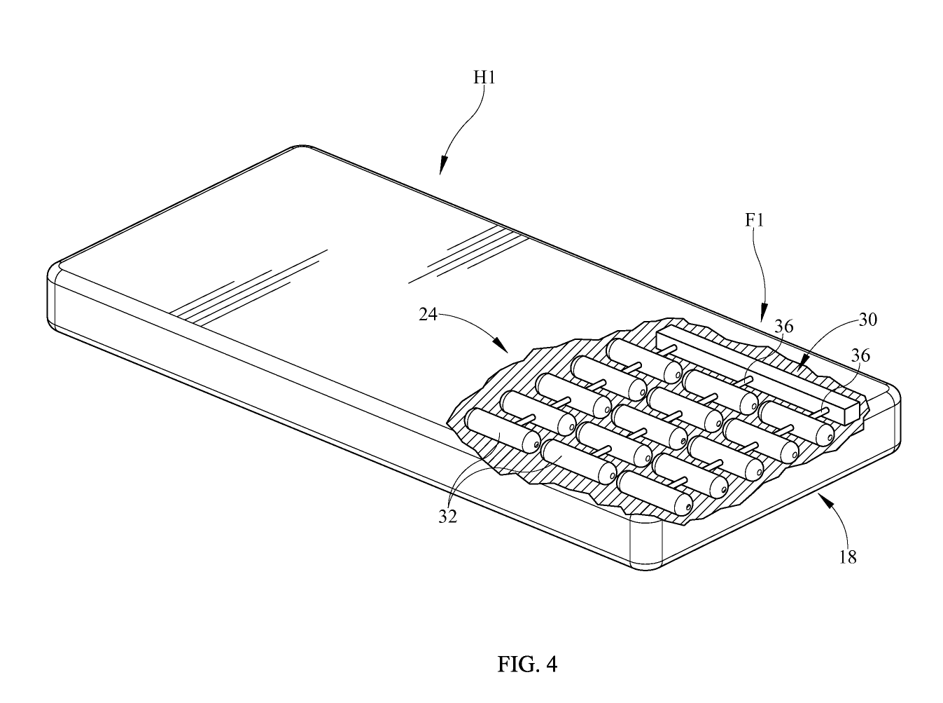

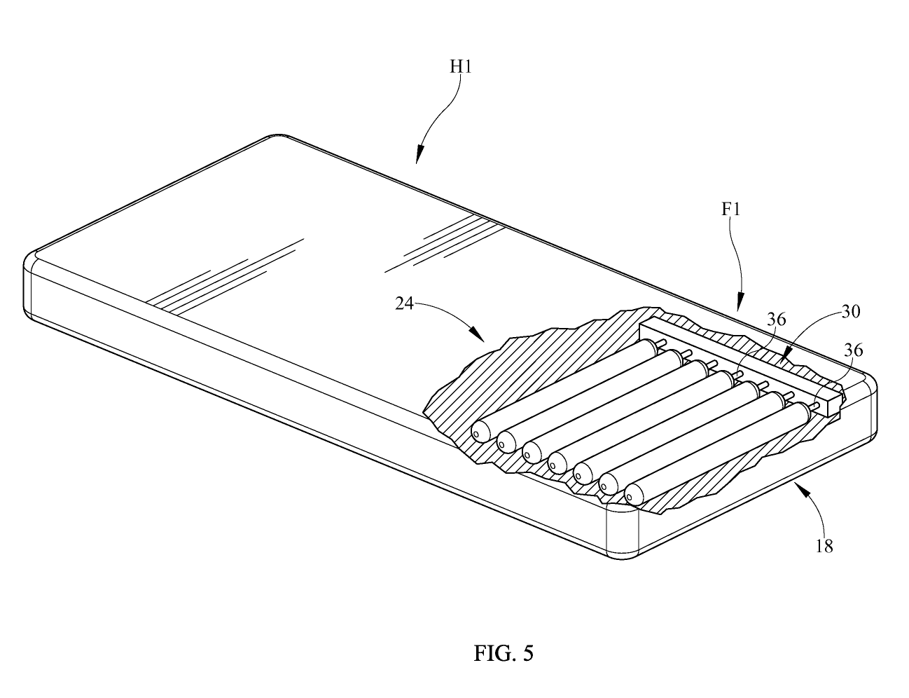

At least one bladder 24 can be coupled to the person-support surface 18 as shown in the FIG. 4 and FIG. 5. It should be appreciated that the at least one bladder 24 is preferably positioned on the foot section Fl of the person-support apparatus 10. It should also be appreciated that at least one bladder 24 can be coupled to the person-support surface 18 by any of the standard attaching mechanism such as gluing, VELCRO® bonding, stitching etc. It should be appreciated that the at least one bladder 24 can also be present below ticking unit 20. According to an illustrative embodiment of the disclosure, the at least one bladder 24 can be arranged along the length of the person-support apparatus 10 as shown in FIG. 4. According to another illustrative embodiment of the disclosure, at least one bladder 24 can be arranged along the breadth of the person-support apparatus 10 as shown in FIG. 5. In one contemplated embodiment, the at least one bladder 24 is configured to deflate and thereby allow for reduction in length of the person-support surface 18.

In one embodiment of the DVT therapy system 22, at least one bladder 24 can also include a series of small bladders 32 as shown in FIG. 4. Each of the small bladders 32 may include a separate valve (not shown in figure) for controlling the flow of fluid. The small bladders 24 can be further helpful in providing a milking action against the limb where the sequential compression therapy is needed.

In one embodiment of the DVT therapy system 22, the controller 26 can be any programmable device configured to control the operation of the valve assembly 30 and the fluid supply unit 28 to generate the milking action of at least one bladder 24. At least one bladder 24 may include at least one pressure sensor 34 configured to sense and send the pressure signal to the controller 26. Depending upon the pressure in at least one bladder 24, the controller 26 can control the opening and closing of the valve assembly 30 to control the pressure in at least one bladder 24.

In one embodiment of the DVT therapy system 22, the fluid supply unit 28 can be removably coupled to the lower frame 12 as shown in FIG. 1 in one embodiment. It should be appreciated that the fluid supply unit 28 can also be present elsewhere on the person-support apparatus 10. It should also be appreciated that air can be used as a fluid. In such a case, the fluid supply unit 28 can be an air pulse generator unit 28. The use of any other fluid is well within the scope of this invention. The fluid supply unit 28 can also be used for other operations of the person-support apparatus 10 such as to provide fluid to a cooling and heating device and continuous high frequency oscillation device for chest physiotherapy. The valve assembly 30 can include at least one valve 36 wherein at least one valve 36 can be coupled to at least one bladder 24. At least one valve 36 can be further coupled to the controller 26 which can be configured to selectively control the opening and closing of at least one valve 36. In operation, at least one pressure sensor 34 can sense the pressure within at least one bladder 24. If the controller 26 determines that the pressure in at least one bladder 24 needs to be increased, then the controller 26 can send a signal to open at least one valve 36. As a result the fluid can pass in to at least one bladder 24. Similarly, the controller 26 can determine that the pressure inside at least one bladder 24 needs to be decreased, then the controller 26 can send another signal for the closing of at least one valve 36. It should also be appreciated that the opening and closing of at least one valve 36 can also be influenced by the caregiver.

According to another illustrative embodiment of the disclosure, the DVT therapy system 22 can include at least one physiological sensor 38. At least one physiological sensor 38 can be configured to sense various parameters such as the heart beat, pulse rate, blood pressure and send the measured parameter to the controller 26. The controller 26 can be configured to determine the physical condition of the person supported on the person support apparatus 10 on the basis of received parameters in one embodiment. If the physical condition of the person is not appropriate to support sequential compression therapy then the treatment can be immediately stopped by the controller 26.

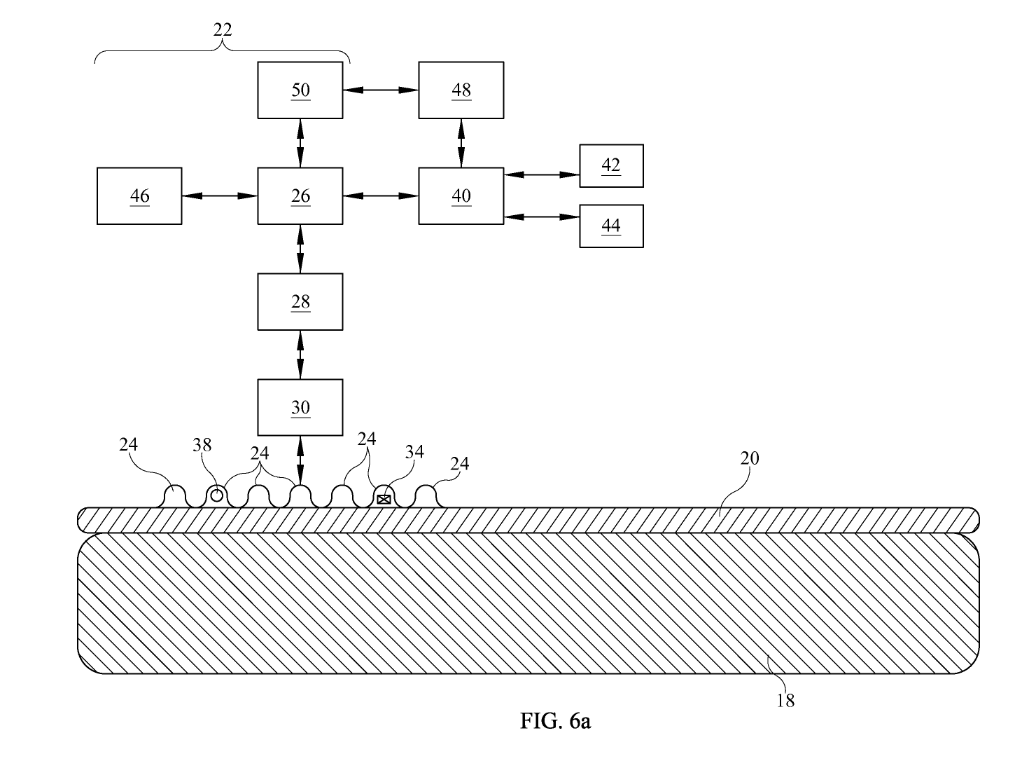

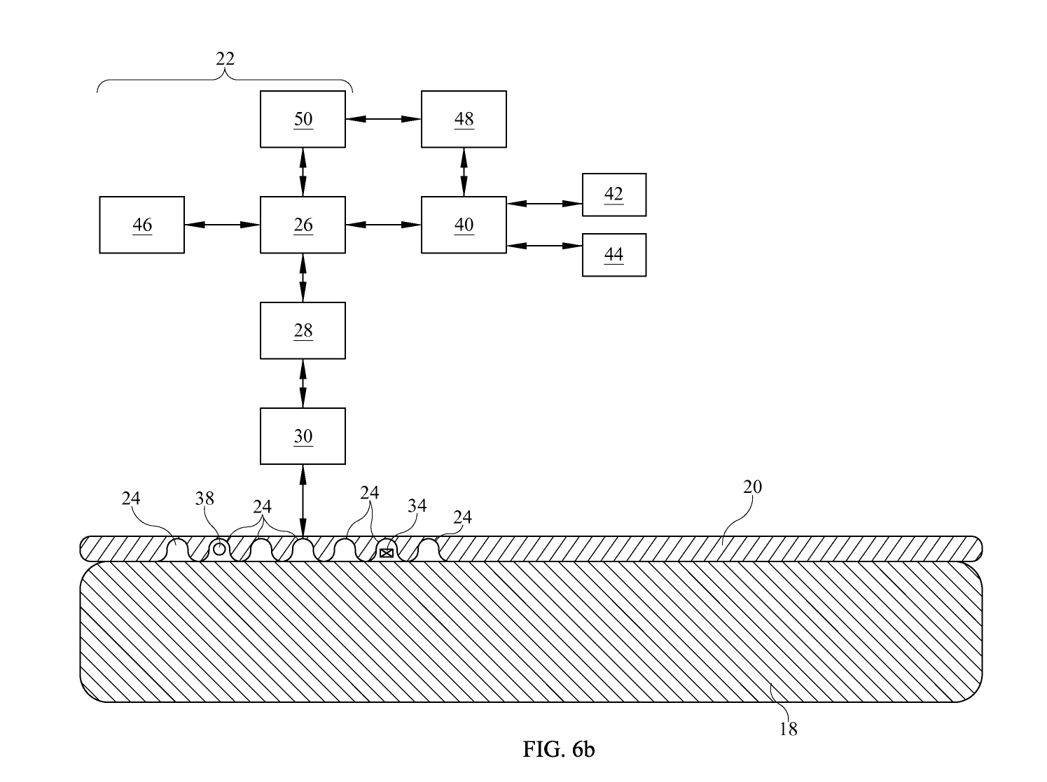

In embodiments shown in FIG. 6A and FIG. 6B, the DVT therapy system 22 communicates with an activity log 50 in connection with the controller 26. The activity log 50 includes a memory device to store recent patient activity. In one embodiment of the claimed subject matter, the controller 26 is further connected to a communication system 40 which may be further connected to a nurse call system 42 and a communication station 44. The communication station 44 may be a stationary control area as may be the case with hospitals or alternatively may be a mobile control area as may be the case in mobile command centers setup for emergency and disaster response. The controller may be connected to the patient's Electronic Medical Records (EMR) 48 via the communication system 40, allowing the controller to receive and transmit data to and from the Electronic Medical Records (EMR) 48. In one embodiment of the claimed subject matter, the activity log 50 may be connected to the Electronic Medical Records (EMR) 48 for access to patient's medical history. In one embodiment of the subject matter, an alarming unit 46 is connected to and triggered by the controller 26. In one embodiment of the subject matter, the controller utilizes information from at least one of Electronic Medical Records (EMR) and activity log 50, along with information from at least one of pressure sensor 34 and physiological sensor 38 mounted on the person-support surface to recommend a therapeutic regime. The physiological sensor 38 may be configured to monitor any physiological signal, including, but not limited to blood pressure, heart rate, temperature and perspiration. Although not shown in the figures, the controller may further include any type of a user interface for input of control parameters, selection of modalities and display of messages. Although not shown in the figures, the controller may further include its own independent pendant or may be incorporated in the pendant usually provided with the patient-support apparatus 10. In one embodiment, at least one bladder 24 is built-in to the ticking unit 20, as shown in FIG. 6A. In another embodiment as shown in FIG. 6B, at least one bladder 24 is affixed on top of the ticking unit 20. In one embodiment, the bladder 24 may be affixed on top of the ticking unit 20 with a removable connection, wherein it would be separable from the ticking unit, or alternatively, the bladder may be affixed to the ticking unit in a non-removable manner in another embodiment.

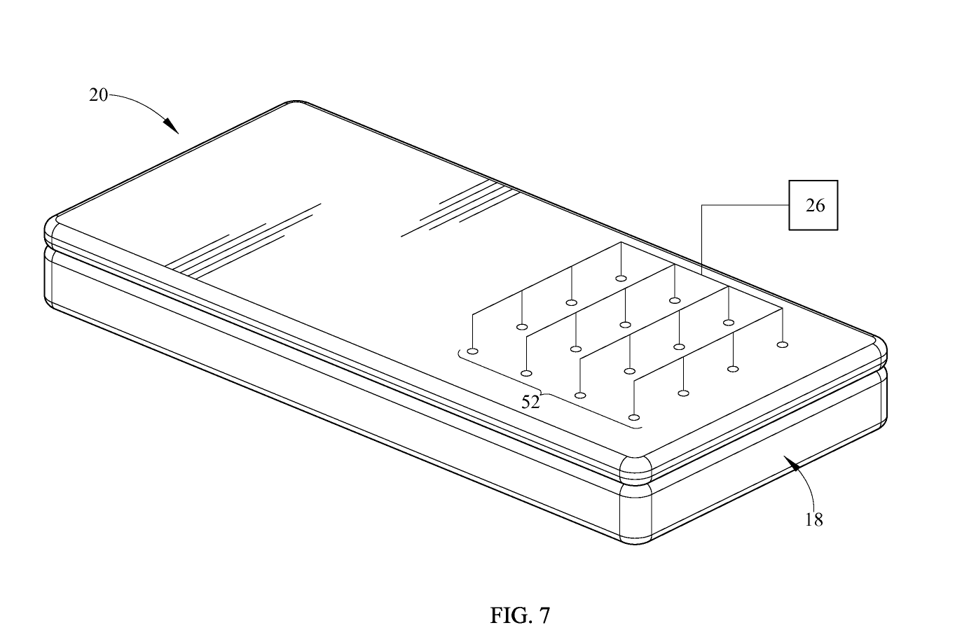

In one embodiment of the DVT therapy system 22, as shown in FIG. 7, at least one mechanical actuation device 52 may be placed below the ticking unit 20, over the ticking unit 20, integral to the ticking unit 20 or integrated in the person-support surface 18. In one embodiment of the DVT therapy system 22 as shown in FIG. 7, the mechanical actuation device 52 is preferably an electro-mechanical transducer, including but not limited to a piezoelectric type of transducer. Upon receiving an actuation signal from the controller 26, the mechanical actuation device 22 provides a mechanical stimulus to the person, such as intermittent impulses or sequential compression. As shown in FIG. 7, several mechanical actuation devices may be used. In one embodiment of the DVT therapy system 22, the mechanical actuation devices are positioned in the lower leg or calf region. In another embodiment, the mechanical actuation devices may alternatively be positioned in the upper body or thigh portions of the person-support surface 18 or ticking unit 20. In one embodiment of the DVT therapy system 22, the mechanical actuation devices may be actuated simultaneously or in a predetermined sequence.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless need not be necessary and embodiments lacking the same can be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles can have been presented, they need not be utilized in combination, and various combinations of inventive aspects and principles are possible in light of the various embodiments provided above.

What is claimed is:

1. A system for prevention of deep vein thrombosis comprising:
a person-support surface comprising a head section and a foot section;
a ticking unit mounted upon at least a portion of said person-support surface;
at least one bladder mounted between said ticking unit and said person-support surface, said at least one bladder configured to provide mechanical tissue stimulation to a person supported on said person-support surface, said bladder mounted in said foot section.

2. The system of claim 1, said mechanical tissue stimulation is at least one of impulse stimulation and sequential compression therapy.

3. The system of claim 1, a valve assembly fluidly connected to said at least one bladder.

4. The system of claim 3, a fluid supply unit fluidly connected to said valve assembly, said fluid supply unit configured to supply fluid to said at least one bladder through said valve assembly.

5. The system of claim 4, a controller connected to at least one of said valve assembly and said fluid supply unit, said controller configured to control the operation of at least one of said valve assembly and said fluid supply unit.

6. The system of claim 1, said at least one bladder aligned along at least one of the length of and breadth of said person-support apparatus.

7. The system of claim 5, said controller in communication with an electronic medical record.

8. The system of claim 5, said controller coupled to at least one physiological sensor, said at least one physiological sensor configured to measure at least one physiological signal, said at least one physiological signal including at least one of blood pressure, heart rate, temperature and perspiration.

9. The system of claim 8, said controller configured to trigger an alarming unit in response to said physiological signal exceeding a predetermined threshold, said alarming unit including at least one of an audible sound, light signal and vibrations.

10. The system of claim 5, said controller in communication with a communication system.

11. The system of claim 10, said communication between said controller and said communication system is wireless.

12. The system of claim 5, said at least one bladder including at least one pressure sensor in communication with said controller.

13. The system of claim 4, said fluid supply unit configured to supply fluid to at least one of a thermal regulating system, physiotherapy system and high frequency oscillation system.

14. A system for prevention of deep vein thrombosis comprising:
a person-support surface comprising a head section and a foot section;
a ticking unit mounted upon at least a portion of said person-support surface;
at least one bladder mounted upon said ticking unit, said at least one bladder configured to provide mechanical tissue stimulation to a person supported on said person-support surface, said bladder mounted in said foot section.

15. The system of claim 14, said mechanical tissue stimulation is at least one of impulse stimulation and sequential compression therapy.

16. The system of claim 14, a valve assembly fluidly connected to said at least one bladder.

17. The system of claim 16, a fluid supply unit fluidly connected to said valve assembly, said fluid supply unit configured to supply fluid to said at least one bladder through said valve assembly.

18. The system of claim 17, a controller connected to at least one of said valve assembly and said fluid supply unit, said controller configured to control the operation of at least one of said valve assembly and said fluid supply unit.

19. The system of claim 14, said at least one bladder aligned along at least one of the length of and breadth of said person-support apparatus.

20. The system of claim 18, said controller in communication with an electronic medical record.

21. The system of claim 18, said controller coupled to at least one physiological sensor, said at least one physiological sensor configured to measure at least one physiological signal, said at least one physiological signal including at least one of blood pressure, heart rate, temperature and perspiration.

22. The system of claim 21, said controller configured to trigger an alarming unit in response to said physiological signal exceeding a predetermined threshold, said alarming unit including at least one of an audible sound, light signal and vibrations.

23. The system of claim 18, said controller in communication with a communication system.

24. The system of claim 23, said communication between said controller and said communication system is wireless.

25. The system of claim 18, said at least one bladder including at least one pressure sensor in communication with said controller.

26. A system for prevention of deep vein thrombosis comprising:
a person-support surface comprising a head section and a foot section;
a ticking unit mounted upon at least a portion of said person-support surface;
at least one bladder integral to at least one of said ticking unit and said person support surface, said at least one bladder configured to provide mechanical tissue stimulation to a person supported on said person-support surface, said bladder mounted in said foot section.

27. The system of claim 26, said mechanical tissue stimulation is at least one of impulse stimulation and sequential compression therapy.

28. The system of claim 26, a valve assembly fluidly connected to said at least one bladder.

29. The system of claim 28, a fluid supply unit fluidly connected to said valve assembly, said fluid supply unit configured to supply fluid to said at least one bladder through said valve assembly.

30. The system of claim 29, a controller connected to at least one of said valve assembly and said fluid supply unit, said controller configured to control the operation of at least one of said valve assembly and said fluid supply unit.

31. The system of claim 26, said at least one bladder aligned along at least one of the length of and breadth of said person-support apparatus.

32. The system of claim 30, said controller in communication with an electronic medical record.

33. The system of claim 30, said controller coupled to at least one physiological sensor, said at least one physiological sensor configured to measure at least one physiological signal, said at least one physiological signal including at least one of blood pressure, heart rate, temperature and perspiration.

34. The system of claim 33, said controller configured to trigger an alarming unit in response to said physiological signal exceeding a predetermined threshold, said alarming unit including at least one of an audible sound, light signal and vibrations.

35. The system of claim 30, said controller in communication with a communication system.

36. The system of claim 35, said communication between said controller and said communication system is wireless.

37. The system of claim 30, said at least one bladder including at least one pressure sensor in communication with said controller.

38. A system for prevention of deep vein thrombosis comprising:
a person-support surface comprising a head section and a foot section;
a ticking unit mounted upon at least a portion of said person-support surface;
at least one mechanical actuation device mounted on at least one of integral to said ticking unit, on top of said ticking unit, below said ticking unit, and integral to said person-support surface, said mechanical actuation device provides mechanical tissue stimulation to a person supported by said person-support surface;
a controller in communication with said at least one mechanical actuation device.

39. The system of claim 38, said controller configured to provide an actuation signal to said at least one mechanical actuation device at predetermined time intervals.
